(19) United States
(12) Patent Application Publication
(10) Pub. No.: US 2023/0323751 A1
(43) Pub. Date: Oct. 12, 2023

(54) SYSTEMS, APPARATUS AND METHODS FOR OCCUPYING ONE OR MORE SPACES IN AN ITEM OF EQUIPMENT OR COMPONENT

(71) Applicant: Paloma Pressure Control LLC, Midland, TX (US)

(72) Inventors: Robert Ripple, Richmond, TX (US); Bryan Wilborn, Midland (us); Colton Trego, Odessa, TX (US)

(21) Appl. No.: 18/131,013

(22) Filed: Apr. 5, 2023

Related U.S. Application Data
(60) Provisional application No. 63/329,167, filed on Apr. 8, 2022.

(51) Int. Cl. E21B 34/06

(52) U.S. Cl. CPC E21B 34/06; E21B 2200/02

(57) ABSTRACT

Apparatus, systems and methods for occupying at least part of a cavity within an item of equipment includes at least one removable insert configured to occupy at least part of the cavity without impeding movement in the cavity of any movable internal components of the equipment during normal operation thereof. Each insert may be configured to be spaced away from at least one among the cavity wall, one or more internal components of the equipment and any other inserts in the cavity and allow the flow of fluid around at least part of the insert in the cavity.

### CROSS REFERENCE TO RELATED APPLICATIONS

The present application claims priority to U.S. Provisional Patent Application Ser. No. 63/329,167 filed on Apr. 8, 2022 and entitled “Systems, Apparatus & Methods for at Least Temporarily Occupying One or More Spaces or Cavities in a Valve or Other Item of Equipment”, the entire contents of which are hereby incorporated by reference herein.

### FIELD OF THE DISCLOSURE

The present disclosure relates generally to systems, apparatus and methods for occupying one or more spaces, voids or cavities in an item of equipment or component and, in some embodiments, systems, apparatus and methods for reducing the volume of fluid that needs to be provided in or flowed through the internal cavity of an item of equipment.

### BACKGROUND

Various types of equipment and components have one or more internal cavities or voids that may be included for any among a myriad of reasons, or simply a result of the item's design or other preferences. Often, some of the space in the cavity is not needed to house any components or accommodate any other features and can be considered essentially as dead space. These unoccupied, unused spaces or voids can lead to inefficiencies, wasted resources, ESG issues, etc. In many instances, at least temporarily reducing the volume of space in the cavity without sacrificing or inhibiting desired operation of the equipment and components therein can have benefits.

For example, certain types of equipment have lubricant or other fluid/materials inside them, such as to lubricate the equipment or components therein, or for another purpose. In certain instances, due to of the location or disposition of the cavity, the lubricant or other fluid/materials inevitably or naturally fills or sits in, or flows through the cavity. In fact, the presence of the cavity can cause a larger volume of lubricant or other fluid/materials to be provided in or moving through the equipment than is really needed for desired operation thereof. In many situations, the larger the cavity, the greater the volume of extra (e.g., unnecessary) lubricant or other fluid/materials that is ultimately provided in or flowed through the equipment. Thus, reducing the (e.g., dead) space in the cavity could reduce the volume of lubricant or other fluid/materials provided inside or moved through the equipment, saving cost, time and manpower, reducing potential environmental impact, providing other benefits or a combination thereof.

For another example, due to the nature and usage of various types of equipment, debris can collect inside and/or flow through the equipment. In some cases, the more unoccupied space in the equipment, such as in one or more cavities, the more debris that can collect therein and/or be driven through the equipment, increasing the potential for equipment damage or blockages, require more frequent maintenance, etc. Accordingly, reducing the volume of open space not needed for operation of certain types of equipment could reduce the amount of debris that collects in or moves through the equipment, saving cost, time or manpower, reducing potential damage, equipment down-time, maintenance and repair, providing other benefits or a combination thereof.

For yet a further example, it may be advantageous to at least partially (e.g., temporarily) reduce the amount space within cavities designed to hold a volume of liquid, material, etc. in certain types of equipment, such as when a particular situation or application warrants the use of less of the fluid, material, etc. One example is vehicle fuel tanks, such as when it is desirable to limit vehicle driving time, or driver-operating time (e.g., between stops or fill-ups), to comply with DOT and/or company regulations, for any other purposes or a combination thereof. Still another example involves equipment having one or more cavities designed to hold air or gas, such as vehicle tires. Reducing the space inside the cavity can, in some instances and applications, allow the tires to be used as intended with less air therein, requiring less time and manpower to fill the tires and less energy to fuel air pumps, for any other purposes or a combination thereof.

Accordingly, there exists a need for apparatus, systems and methods useful for at least temporarily occupying space in one or more cavities in an equipment item.

It should be understood that the above-described disadvantages, limitations, features, capabilities, examples, advantages and other details are provided for illustrative purposes only and are not intended to limit the scope or subject matter of this disclosure or the appended claims. Thus, none of the appended claims should be limited by the above discussion or construed to address, include or exclude each or any of the above-cited disadvantages, limitations, features, capabilities, examples, details or advantages merely because of their mention above.

### BRIEF SUMMARY OF EXEMPLARY EMBODIMENTS

The present disclosure involves the use of one or more inserts in the cavity or cavities of an item of equipment and which, depending upon the particular application, circumstances and other variables, possesses one or more attributes, features or capabilities below, described or shown elsewhere in this patent, or which may be apparent therefrom: one or more inserts (e.g., 2, 3,4 or more) at least partially fills one or more cavities in the equipment when the equipment is fully assembled; may be used in part or all of the open spaces in a cavity; is designed so the same version of insert may be used in different portions of a cavity in equipment and, thus, the inserts may be interchangeable; can be permanent or removable, integral with or separate from the equipment; is easily added to and removable from an existing equipment item; can be used to retrofit an item of equipment and/or without modifying the equipment; may be provided in new or used equipment; may be easily added to existing commercially available valves of numerous suppliers and manufacturers; may be insertable into an A.P.I. 6A gate valve used in well-fracturing and related operations; can be coupled to the equipment, one or more component thereof, another one or more inserts or a combination thereof; can be free-floating within the cavity; may be fastenable to one or more removable components or portions of the equipment to allow for ease of installation, removal, cleaning, repair and replacement of the inserts; may involve one or more points to secure the insert's position in the cavity and/or prevent its rotation; can be designed to function in suitable equipment (e.g., valves) having virtually any make, model, size, pressure and temperature ratings and manufacturer; can be functional in normal operating temperatures of the equipment (e.g., −20° F. to 250° F. in gate valves used in hydraulic fracturing operations); can be functional within the full range of expected working pressures of the equipment; allows normal operation of the equipment (e.g., per manufacturer's specification); may be used with, and allow full functionality, of the equipment (e.g., handwheel and actuator-operated valves); can be used and fully functional in equipment involving the flow or presence of fluids; can be used and fully functional in oilfield equipment (e.g., valves) involving the flow or presence of frac, wellbore, completion and/or injection fluids; decreases the volume (e.g., by at least 50% (or more or less)) of lubricant (or other liquids, gases, substances, materials, etc. or a combination thereof) normally provided in the cavity or cavities and/or which may be driven through and/or out the equipment; may be fully functional in suitable valves used in environments dictated by A.P.I. valve trim levels, such as AA-FF; may be used in gate (or other) valves and allow full gate travel between open and closed positions (e.g., during multiple cycles in short time intervals); can be designed to provide fluid flow paths to allow for travel of fluids in the cavity; provides fluid flow paths to allow for travel of lubricant in the cavity as needed or desired to lubricate the internal components of the equipment as dictated by manufactures specifications and field of use requirements; can minimize the amount of grease (or other fluids) injected into various types of valves or other equipment during multiple short-term intervals of operation (opening and closing) within the full working pressure range of the valve or other equipment; can be configured to function without impeding the normal or expected operation of the equipment, including movement of internal valve components; can be used in equipment that does not include the injection, or even use, of lubricant (or other liquids, gases, substances, materials, etc. or a combination thereof) in the cavity or cavities; can reduce or minimize the area in the cavity of the equipment in which debris (e.g., sand, metal shavings, proppant, etc.) can accumulate and thus decrease the amount of debris in the equipment during operations; can reduce the frequency of inspection, maintenance, cleaning, repair and replacement of the equipment (e.g., due to reduction in the volume of fluids (e.g., lubricant) and debris to accumulate); makes cleaning and repair of the equipment easier, quicker, less frequent, less costly or a combination thereof; can preserve equipment integrity longer and improve the lifespan, performance and efficiency of the equipment, its maintenance and operations and the need for associated resources; can be designed or modified to fit suitable OEM valve designs and other equipment; or a combination thereof.

In some embodiments, the present disclosure involves systems useful for reducing the volume of fluid provided in the internal cavity of an item of equipment which normally involves the inclusion of fluid in the cavity and may have one or more (e.g., moveable) internal components at least partially disposed within the cavity. These embodiments include at least two removable inserts, each being configured to occupy a different respective portion of the cavity without impeding movement in the cavity of any movable internal components during use of the equipment. When the inserts are disposed in the cavity, each insert is arranged and adapted to be spaced away from at least one cavity wall, any internal components and the other insert(s). Each insert is configured to form a plurality of fluid flow paths around the insert, whereby fluid can pass around at least part of each insert in the cavity when the insert is disposed in the cavity. The inserts are interchangeable so that any of the inserts can be used in any of the different portions of the cavity.

If desired, any of the following features may be included. At least one insert may be configured to form one or more fluid flow paths between the insert and one or more adjacent internal components, cavity walls and/or other inserts. At least one insert may have one or more fluid flow paths extending at least partially across one or more outer surfaces of the insert. At least one insert may have one or more fluid passageways extending through it and allowing fluid flow therethrough from one to another portion of the cavity. For example, one or more passageways may extend through it from the front end to the rear end thereof and fluidly couple one or more portions of the cavity forward and one or more portions of the cavity rearward of the insert. For another example, one or more fluid passageways may extend from the upper end to the lower end thereof and fluidly couple one or more portions of the cavity above and one or more portions of the cavity below the insert.

At least one insert may be coupled to the equipment item, one or more internal components and/or one or more other inserts with one or more connectors engaged therebetween, with the insert(s) configured to allow the flow of fluid around the entire periphery of the insert, except where the connector(s) engage the insert if the insert is coupled to something else in the cavity. Each insert may be releasably coupled to one or more other inserts. At least one insert may be rigidly, releasably connectable to the equipment item, one or more internal components and/or at least one other insert. At least one insert may be releasably engageable with the equipment item. Each insert may be releasably engageable with the equipment item. One or more inserts may not be coupled to the equipment item and may float in the cavity.

At least one insert may consist of a single unitary body having no protrusions extending outwardly therefrom configured to maintain its integrity and withstand the forces and abrasion of high-pressure fluid in the cavity. If desired, three, four or more inserts may be used and configured to be added to the equipment item to retrofit the equipment item. A first pair of inserts facing each other may be positionable in an upper portion of the cavity and a second pair of inserts facing each other may be positionable in a lower portion of the cavity. The inserts may be configured to be used in the equipment item without modifying the equipment item.

The equipment may have at least a first removable portion adjacent to, or at least partially forming, the cavity and at least a first insert may be configured to be secured in a desired position in the cavity by releasably engaging the first insert with only with the first removable portion of the equipment. The first insert may be removable from the equipment item by merely removing the first removable portion. When the equipment item has a removable upper end piece adjacent to, or at least partially forming, the upper end of the cavity and a removable lower end piece adjacent to, or at least partially forming, the lower end of the cavity, at least a first insert may be configured to be releasably engageable only with the upper end piece and at least a second insert may be configured to be releasably engageable only with the lower end piece, so that the first insert is removable from the equipment item by merely removing the upper end piece and the second insert is removable from the equipment item by merely removing the lower end piece.

At least first and second spaced-apart releasable connectors may be configured to extend between and couple at least one insert to the equipment item, securing the insert in a desired location in the cavity and preventing rotation of the insert relative to the equipment item. At least one insert may have first and second spaced-apart connector passages extending between the upper and lower ends thereof, and be configured so that the first and second connectors are insertable into the respective connector passages from the lower end to the upper end of the insert and thereafter engageable with the equipment item. Each connector may have a head at the first end thereof and at least one insert may be configured so that the head of each connector engaged therewith is sunken in the insert and not protruding outward of the outer surface(s) of the insert when the connector is used to couple the insert with the equipment item. Each connector passage may be configured to serve as a fluid passageway through the corresponding insert when a connector is not disposed therein.

In various embodiments, the present disclosure involves methods of reducing the volume of fluid provided in the internal cavity of an item of equipment which normally involves the inclusion of fluid in the cavity and may have one or more internal components at least partially disposed within the cavity. At least one internal component may be moveable in the cavity. These methods include arranging at least two removable inserts in the cavity to occupy different respective portions of the cavity and be spaced away from the cavity wall(s) and any internal components in the cavity. The inserts are interchangeable so that any of the inserts can be used in any of the different portions of the cavity. The inserts allow movement in the cavity of any movable internal components of the equipment during use thereof without impeding such movement. Each insert forms a plurality of fluid flow paths around the insert and allows fluid to pass around at least part of the insert in the cavity.

If desired, any of the following features may be included. Each fluid flow path may be formed between the respective corresponding insert and one or more adjacent internal component in the cavity, cavity walls and other inserts. At least one fluid flow path of each insert may extend at least partially across each outer surface thereof. Each insert may include one or more fluid passageways extending through the insert from the front to the rear end thereof and fluidly coupling at least one portion of the cavity forward of the insert with at least portion of the cavity rearward of the insert when the insert is disposed in the cavity. One or more fluid passageways may extend through any portion(s) thereof to allow fluid to flow therethrough and between different parts of the cavity. For example, one or more fluid passageways may extend through each insert from the upper end to the lower end thereof and fluidly couple at least one portion of the cavity above the insert with at least one portion of the cavity below the insert when the insert is disposed in the cavity.

Each insert may consist of a single unitary body having no protrusions extending outwardly therefrom and being configured to maintain its integrity and withstand the forces and abrasion of high-pressure fluid in the cavity. A first pair of inserts may be positioned to face each other in an upper portion of the cavity and a second pair of inserts may be positioned to face each other in a lower portion of the cavity. The inserts may be positioned and used in the cavity without modifying the equipment item.

At least one insert may be releasably coupled to the equipment item, at least one internal component and/or one or more other inserts with one or more connectors engaged therebetween. Each insert may allow the flow of fluid around the entire periphery of the insert when the insert is disposed in the cavity, except where at least one connector engages the insert if the insert is coupled to something else in the cavity.

At least one insert may be releasably coupled to one or more other inserts in the cavity and/or releasably engaged with the equipment item. Each insert may be rigidly, releasably connected to equipment item, at least one internal component in the equipment item and/or one or more other inserts. Each insert may be releasably engaged with the equipment item. Each insert may not be coupled to the equipment item and may float in the cavity.

The equipment may have at least a first removable portion adjacent to, or at least partially forming, the cavity and at least a first insert may be configured to be secured in a desired position in the cavity by releasably engaging the first insert with only with the first removable portion of the equipment. The first insert may be removable from the equipment item by merely removing the first removable portion. When the equipment item has a removable upper end piece adjacent to, or at least partially forming, the upper end of the cavity and a removable lower end piece adjacent to, or at least partially forming, the lower end of the cavity, at least a first insert may releasably engage only the upper end piece and be removable from the cavity by merely removing the upper end piece, and at least a second insert may releasably engage only the lower end piece and be removable from the cavity by merely removing the lower end piece.

At least first and second spaced-apart, releasable connectors may extend between and couple each respective insert to the equipment item when the inserts are disposed in the cavity. The first and second connectors associated with each insert may secure the insert in a desired location in the cavity and prevent rotation of the insert relative to the equipment item. Each insert may have first and second spaced-apart connector passages extending between the upper and lower ends thereof. Each connector may be inserted into a respective connector passage of an insert from the lower end to the upper end of the insert and thereafter engage the equipment item. Each connector may have a head at the first end thereof that fits into a recess in the corresponding insert and does not protrude outward of the outer surface of the insert when the connectors are engaged between the insert and equipment item. When a connector is not disposed within any connector passage, the connector passage may serve as a fluid passageway through the insert, fluidly coupling at least one portion of the cavity above the insert with one or more portions of the cavity below the insert.

In many embodiments, the present disclosure involves methods of reducing the volume of fluid provided in the internal cavity of an item of equipment which normally involves the inclusion of fluid in the cavity and may have one or more internal components at least partially disposed within the cavity. At least one internal component may be moveable in the cavity. At least two removable inserts are arranged in the cavity to occupy different respective portions of the cavity and be spaced away from the cavity wall and any internal components in the cavity. The inserts are interchangeable so that any of the inserts can be used in any of the different portions of the cavity. The inserts allow movement in the cavity of any movable internal components of the equipment during use thereof without impeding such movement. One or more fluid passageways extending through each insert allow fluid to pass from one or more portions of the cavity to one or more portions of the cavity.

The present disclosure also includes embodiments of systems for reducing the volume of high-pressure lubricant injected into a through-conduit valve during use of the valve in oilfield related operations. The valve has an internal cavity at least partially surrounded by at least one cavity wall and one or more internal components disposed at least partially in the cavity. At least one internal component is movable in the cavity during use of the valve. These systems include at least two removable inserts, each being unitary and having no protrusions extending outwardly therefrom and configured to occupy a different respective portion of the cavity without impeding movement of the movable internal component(s) during use of the valve. Each insert, when disposed in the cavity, is arranged and adapted to be spaced away from, and allow lubricant to pass between itself and, the cavity wall(s), any adjacent internal components and the other insert(s).

If desired, any of the following features may be included. Each insert may be arranged, adapted and configured to maintain its integrity and withstand the forces and abrasion of high-pressure lubricant in the cavity. At least one insert may be configured, when disposed in the cavity, to form one or more lubricant flows paths between the insert and at least one adjacent internal component, cavity wall and/or other insert. At least one insert may include one or more lubricant flow paths extending at least partially across at least one outer surface of the insert. One or more fluid passageways may extend through the insert from the front end to the rear end thereof and fluidly couple one or more portions of the cavity forward and one or more portions of the cavity rearward of the insert when the insert is disposed in the cavity. At least one fluid passageway may extend through the insert from the upper end to the lower end thereof and fluidly coupling one or more portions of the cavity above and one or more portions of the cavity below the insert when the insert is disposed in the cavity.

At least one insert may be coupled to the valve, one or more internal components and/or at least one other insert with one or more connectors engaged therebetween, and configured to allow the flow of lubricant around the entire periphery of the insert when the insert is disposed in the cavity except where at least one connector engages the insert if the insert is coupled to something else in the cavity. Four inserts may be used and configured to be added to the valve to retrofit the valve. A first pair of inserts facing each other may be positionable in an upper portion of the cavity and a second pair of inserts facing each other may be positioned in a lower portion of the cavity. The inserts may be configured to be used in the valve without modifying the valve.

Each insert may be releasably coupled to one or more other inserts. At least one insert may be releasably engageable with the valve. Each insert may be releasably engageable with the valve. At least one insert may be rigidly, releasably connectable to the valve, at least one internal component and/or one or more other inserts. At least one insert may not be coupled to the valve and may float in the cavity. The inserts may be interchangeable so that any of the inserts can be used in any of the different portions of the cavity.

The valve may have at least a first removable portion adjacent to, or at least partially forming, the cavity and at least a first insert may be configured to be secured in a desired position in the cavity by releasably engaging the first insert with only with the first removable portion of the equipment. The first insert may be removable from the valve merely removing the first removable portion. When the valve has a removable upper end piece adjacent to, or at least partially forming, the upper end of the cavity and a removable lower end piece adjacent to, or at least partially forming the lower end of the cavity, at least a first insert may be configured to be releasably engageable only with the upper end piece and at least a second insert may be configured to be releasably engageable only with the lower end piece, the first insert being removable from the equipment by merely removing the upper end piece and the second insert being removable from the equipment by merely removing the lower end piece.

At least first and second spaced-apart releasable connectors may be configured to extend between and couple at least one insert to the valve to secure the insert in a desired location in the cavity and prevent rotation of the insert relative to the valve. One or more inserts may have first and second spaced-apart connector passages extending between the upper and lower ends thereof, and be configured so that the associated first and second connectors are insertable into the respective connector passages from the lower end to the upper end of the insert and thereafter engageable with the valve. At least one insert may be configured so that a head at one end of each connector engaged therewith is sunken in the insert and not protruding outward of the outer surface of the insert when the connector is used to couple the insert with the valve. Each connector passage may be configured to serve as a fluid passageway through the corresponding insert when a connector is not disposed therein.

The cavity may be at least partially cylindrical and have an upper base at one end at a lower base at the other end. The valve may have a removable upper bonnet adjacent to, or at least partially forming, the upper base of the cavity and a removable lower bonnet adjacent to, or at least partially forming, the lower base of the cavity. A first insert may be releasably engageable with the upper bonnet and a second insert may be releasably engageable with the lower bonnet. The first insert may be secured in the valve only by engagement with the upper bonnet and the second insert may be secured in the valve only by engagement with the lower bonnet, wherein the first and second inserts are removable from the valve merely by disconnecting the upper and lower bonnets from the valve, respectively.

In certain embodiments, the present disclosure involves apparatus for occupying at least part of a cavity within an item of equipment. The apparatus includes at least two removable inserts configured to each occupy a different portion of the cavity. The inserts are interchangeable so that any of the inserts can be used in any of the different portions of the cavity. Each insert is configured to allow fluid to pass around at least one outer surface thereof in the cavity and includes one or more fluid passageways extending, and configured to allow fluid to pass, through the insert to fluidly couple the cavity on different sides of the insert. At least one connector passage, distinct from the fluid passageway(s), extends through each insert and is configured to at least partially contain a removable, releasable connector. Each connector is engageable between the corresponding insert and either the equipment item or another insert and is configured to help secure the position of the insert in the cavity. Each connector passage is configured to serve as an additional fluid passageway through the corresponding insert when a connector is not disposed therein.

In various embodiments, the present disclosure involves apparatus for occupying at least part of a cavity within a valve, the valve having at least one internal component at least partially disposed and moveable in the cavity. The apparatus includes one or more inserts configured to occupy a portion of the cavity without contacting or impeding movement of the internal component(s). Each insert is also configured to allow the passage of lubricant thereby and is rigidly, releasably connectable to the valve, at least one internal component and/or one or more other inserts.

There are also embodiments of systems for occupying at least part of a cavity within a valve, the valve having at least one internal component that is movable in the cavity during operation of the valve and one or more lubricant injection ports through which pressurized lubricant is injectable into the cavity. The systems include at least two unitary inserts, each having a main body and no protrusions extending outward therefrom. Each insert is configured to occupy a different portion of the cavity without impeding movement of the movable internal component(s) during operation of the valve. A plurality of fluid flow paths extends around the entire periphery of each insert in the cavity and is configured to allow the passage of lubricant injected into the cavity around the entire periphery of insert.

In certain embodiments, the present disclosure involves methods of lubricating a valve, the valve having an internal cavity and one or more lubricant injection ports fluidly coupled to the internal cavity. These methods include providing one or more removable inserts in the valve cavity. During at least part of the operation of the valve, lubricant is continuously injected into the valve cavity through one or more lubricant injection ports. At least one insert partially inhibits the flow of lubricant in the valve cavity. One or more inserts reduce the volume of lubricant injected into the cavity. At least one insert assists in directing the flow of lubricant through at least part of the cavity.

A method of cleaning an item of equipment having a removable portion and an internal cavity within which lubricant is provided and debris enters during operation of the equipment item includes releasably securing at least one insert to the removable portion of the equipment item. The removable portion is then secured to the equipment item, which positions the insert(s) in a desired position in the cavity. Each insert provides one or more fluid flow paths around the insert and one or more fluid passageways through the insert, which allow lubricant to pass around and through the insert, respectively, during operation of the equipment item. The removable portion of the equipment item (with the insert(s) coupled thereto) is removed from the equipment item. The fluid flow paths and fluid passageways of each insert are flushed to remove lubricant and debris therefrom. The removable portion of the equipment item, with the insert(s) coupled thereto, is returned to the equipment item. If desired, the cavity may be flushed to remove lubricant and debris therefrom. In some embodiments, two inserts may be coupled to the removable portion of the equipment item. The equipment item may include two removable portions, each being an end piece, and at least one (e.g., two) inserts may be secured to each end piece.

Accordingly, the present disclosure includes features and advantages which are believed to enable it to advance technologies involving equipment having internal cavities. Characteristics and advantages of the present disclosure described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1 is a cross-sectional view of an exemplary gate valve showing a cavity therein and having various components at least partially disposed in the cavity;

FIG. 2 is a cross-sectional view of the exemplary gate valve of FIG. 1 having multiple of the exemplary inserts of FIGS. 5-8 in the illustrated cavity in accordance with one or more embodiments of the present disclosure;

FIG. 3 is a partial cutaway view of the exemplary gate valve shown in FIG. 1;

FIG. 4 is a partial cutaway view of the exemplary gate valve shown in FIG. 1 having four of the exemplary inserts of FIGS. 5-8 (without any exemplary connectors) in the illustrated cavity without any exemplary connectors in accordance with one or more embodiments of the present disclosure;

FIG. 5 is a top view of an exemplary insert in accordance with one or more embodiments of the present disclosure;

FIG. 6 is a perspective view of the exemplary insert shown in FIG. 5;

FIG. 7 is a front view of the exemplary insert shown in FIG. 5;

FIG. 8 is a side view of the exemplary insert shown in FIG. 5;

FIG. 9 is a perspective view of another exemplary insert in accordance with one or more embodiments of the present disclosure;

FIG. 10 is a front view of the exemplary insert shown in FIG. 9; and

FIG. 11 is a side view of the exemplary insert shown in FIG. 9.

### DETAILED DESCRIPTION OF EXEMPLARY EMBODIMENTS

Characteristics and advantages of the present disclosure and additional features and benefits will be readily apparent to those skilled in the art upon consideration of the following detailed description of exemplary embodiments and referring to the accompanying figures. It should be understood that the description herein and appended drawings, being of exemplary embodiments, are not intended to limit the claims of this patent (or any patent or patent application claiming priority hereto). On the contrary, the intention is to cover all modifications, equivalents and alternatives falling within the spirit and scope of this disclosure and the claims. Many changes may be made to the particular embodiments and details disclosed herein without departing from such spirit and scope.

In showing and describing preferred embodiments in the appended figures, common or similar components, features and elements are referenced with like or identical reference numerals or are apparent from the figures and/or the description, claims and other parts of this patent herein. The figures are not necessarily to scale and certain features and certain views of the figures may be shown exaggerated in scale or in schematic in the interest of clarity and conciseness.

When reference numbers are followed by a lowercase letter (e.g., connectors 110a, 110b), they are each the same type of component or item (e.g., a connector 110) having the same features, but having a different location, use or other characteristic(s). As used herein and throughout various portions (and headings) of this patent (including the claims), the terms “invention”, “present invention” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

Certain terms are used herein and in the appended claims to refer to particular features and components. As one skilled in the art will appreciate, different persons may refer to a feature or component by different names and this document does not intend to distinguish between components and features that differ in name but not function.

Reference herein and in the appended claims to components, features and aspects in a singular tense does not necessarily limit the present disclosure or appended claims to only one such component, feature or aspect, but should be interpreted generally to mean one or more, except and only to the extent as may be expressly specified otherwise herein or in any particular claims hereof and only for such specific references or claims and other claims depending therefrom. The use of “(s)” in reference to an item, aspect, component, feature or action (e.g., “surface(s)”) should be construed to mean “at least one”.

As used throughout and in all parts of this patent, the following terms have the following meanings, except and only to the extent as may be expressly specified otherwise:

The term “and/or” as used herein provides for three distinct possibilities: one, the other or both. All three possibilities do not need to be available—only any one of the three. For example, if an embodiment of a component is described as “having a collar and/or a coupling”, it may include only one or more collars, only one or more couplings or at least one of each. Thus, the use of “and/or” herein does not require all three possibilities, just any one or more of the three possibilities. A claim limitation that recites “having a collar and/or a coupling” would be literally infringed by a device including only one or more collars, one or more couplings or both one or more couplings and one or more collars.

The phrase “at least one among” as used herein generally has the same meaning as “and/or”. For example, if an embodiment of a component is described as “having at least one among a collar, a coupling and a connector”, it may include only one or more collars, only one or more couplings, only one or more connectors or any combination thereof. Thus, the use of “at least one among” herein and in any claims related hereto does not require all those possibilities to be available, just any one or more of them. Accordingly, a claim limitation that recites “having at least one among a collar, a coupling and a connector” would be literally infringed by a device including only one or more collars, one or more couplings, one or more connectors or any combination thereof.

The terms “automated” and variations thereof as used herein refer to and mean being capable of operating or performing one or more tasks with minimal or no human intervention. Some examples of automation involve the use of one or more electronic devices (e.g., computers, robotics, AI, IoT).

The terms “cavity” and variations thereof refer to an include one or more spaces, voids, areas or the like located inside an item of equipment.

The terms “connector”, “coupling” and the like, and variations thereof, mean and include any form of hardware or configuration of components that causes the referenced items to be connected together. The present disclosure and appended claims are thus not limited to the specific types of couplings and connectors shown in the appended drawings, except and only to the extent as may be expressly specified otherwise herein or in any particular claims hereof and only for such specific references or claims and other claims depending therefrom.

The terms “coupled”, “connected”, “engaged” and the like, and variations thereof refer to and include either an indirect or direct connection or engagement. Thus, if a first device couples to a second device, that connection may be through a direct connection, or through an indirect connection via other devices and/or connections, except and only to the extent as may be expressly specified otherwise herein or in any particular claims hereof and only for such specific references or claims and other claims depending therefrom.

The terms “elongated” and variations thereof as used herein mean and refer to an item having an overall length (during the intended use of the item) that is greater than its average width.

The terms “end piece” and variations thereof refer to and include a removeable portion, or component, of an equipment item at or proximate to an end, side or other party of a cavity in the equipment item. When the end piece is removed, the cavity is at least partially accessible.

The terms “entire periphery” and variations thereof means at least 80% of the literal entirety of the periphery.

The terms “equipment”, “equipment item” and variations thereof refer to and include one or more components, machines, devices, systems or other items that have one or more cavities therein. Some non-limiting examples of equipment are valves, chokes, blow-out preventers, hydraulic cylinders/actuators, gas pressure/volume applications, tanks (e.g., fuel tanks, storage tanks), tires, such as vehicle tires, and the like. The equipment may be of a type used, for example, in the construction, transportation and shipping industries and the traditional, renewable and alternative energy industries, such as the nuclear, wind, solar, coal, hydro, biofuels (e.g., ethanol and biodiesels) battery and oil & gas (e.g., upstream, midstream and downstream operations) industries and combinations thereof.

The terms “float” and variations thereof, when used herein in the context of the relationship of one or more inserts with an equipment item or cavity therein, means and refers to the insert being moveable in the cavity relative to the equipment item.

The terms “fluid” and variations thereof refer to and include liquids, gas and/or solids, including, without limitation, foam, gel, solvent, chemicals, lubricant, grease, oil, hydraulic fluid, materials, particles, proppant, slurry or a combination thereof. The type of fluid is not limiting upon the present disclosure or appended claims, except and only to the extent as may be expressly specified otherwise herein or in any particular claims hereof and only for such specific references or claims and other claims depending therefrom.

The terms “flush” and variations thereof refer to and include rinse, wash, clean, spray and the like with air, water, any suitable cleaning solutions or other fluids. Flushing may include, for example, using a hose or nozzle at one end of the area to be flushed (e.g., fluid passageway) to jettison fluid through or across the area.

The terms “for example, “e.g.,”, “such as” and variations thereof are used to provide one or more possible examples of the referenced item, feature, detail, circumstance, etc. that may occur in some instances. Such examples are not required for every embodiment or any claims, except and only to the extent as may be expressly specified otherwise herein or in any particular claims hereof and only for such specific references or claims and other claims depending therefrom.

The terms “high-pressure” and variations thereof will depend upon the type of equipment item, application, circumstances of use, other variables or a combination thereof, as are and become further known to one of ordinary skill in the art. For example, high-pressure lubrication may be injected into an exemplary API 6A gate valve presently used in certain oilfield related operations at pressures over 10,000 psi, or more or less, any amount of which could be considered high-pressure depending upon the type of equipment item, application, circumstances of use, other variables or a combination thereof.

The terms “including” and “comprising” are used herein and in the appended claims in an open-ended fashion, and thus should be interpreted to mean “including, but not limited to”.

The terms “minimal” and variations thereof generally mean no more than 5-10%.

The terms “party”, “user”, “entity”, “person”, “operator”, “assembler”, “manpower”, “labor” and the like refer to and include one or more humans, legal entities, virtual entities, beings and avatars, robots and robotic components, artificial intelligence-driven components/circuitry, other entities, components and the like or the effort thereof.

The terms “rigidly coupled” and variations thereof mean connected together in a manner that is intended not to allow any, or more than an insubstantial or minimal amount of, relative movement therebetween as is expected during typical or expected operations. In other words, if components A and B are rigidly coupled together, they are not movable relative to one another (more than a minimal or insubstantial amount) during typical or expected operations.

The terms “substantial” and variations will depend upon the type of equipment item, application, circumstances of use, other variables or a combination thereof, as are and become further known to one of ordinary skill in the art. In some instances, such when used to describe the amount or degree of something (e.g., “reduces a substantial volume of fluid”), substantial may mean by at least 40% (or more or less) of the normal or expected amount or degree of the referenced item, variable, criteria, etc.

It should be noted that any of the above terms may be further explained, defined, expanded or limited below or in other parts of this disclosure. Further, the above list of terms is not all inclusive, and other terms may be defined or explained below or in other sections of this patent.

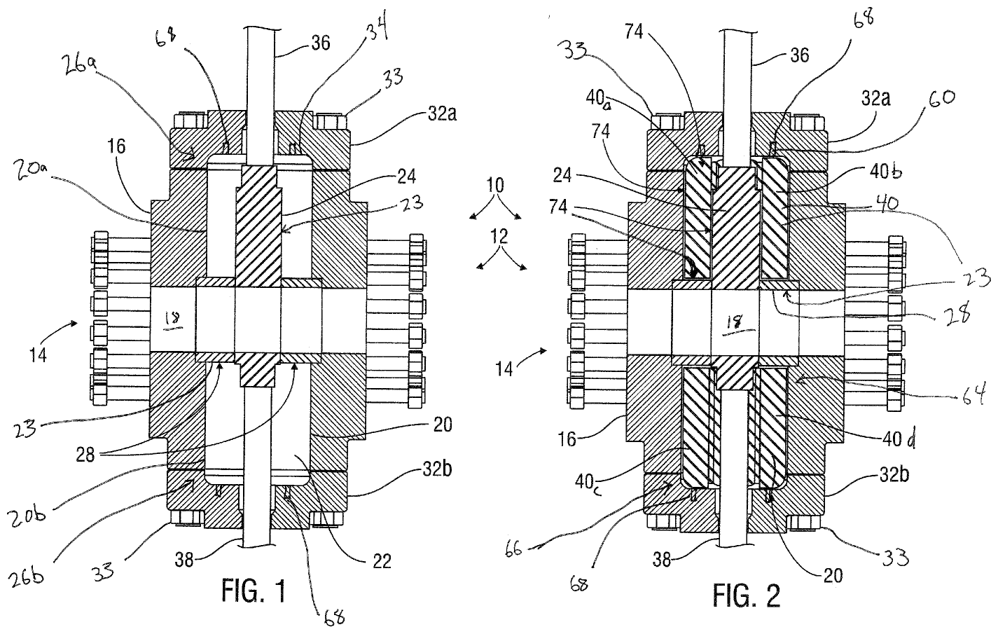

Referring initially to FIGS. 1-4, many types of equipment 10 have one or more cavities 20 formed therein. The equipment may have any form, configuration, components and operation. The illustrated equipment item 10 has a main body 16 within which the cavity 20 is at least partially formed and at least one removable portion 32 at or proximate to at least one end 26 of the cavity 20. For example, a respective removable portion 32 of the item 10 may be adjacent to, form, or border the opposing upper and lower ends, or bases, 26a, 26b, or other parts, of the cavity 20. The cavities 20 may be a result of the item's 10 design or other preferences and/or may have one or more purposes, such as to allow for ease of installation of one or more internal components 23 into the equipment 10, movement of internal components 23 inside the equipment 10, storage of lubricant within the equipment 10 and/or for any other purpose(s). For example, various valves 12, such as gate valves 14, used in oilfield related operations, often have large internal cavities 20 may allow ease of installation of the gate 24 and/or other internal components 23 (e.g., valve seats 28, gate guides) into the valve 12, allow the gate 24 and/or other components to move in the valve 14 as desired, allow lubricant to be stored in the valve 12 (e.g., between long-term intervals between operations), for any other purposes or a combination thereof.

In accordance with various embodiments of the present disclosure, one or more inserts 40 is provided in one or more cavities 20 of the equipment 10 to at least temporarily occupy space therein. For the reader's convenience, inserts 40 are shown and described herein with respect to their exemplary use in valves 12. The illustrated valve 12 has upper and lower respective removable portions 32a, 32b (e.g., bonnets) rigidly, releasably coupled to the main valve body 16, and which form, or border, the upper and lower respective ends 26a, 26b of a single cylindrical cavity 20, a through-conduit 18 and various internal components 23 (e.g., gate 24, seats 28) at least partially disposed in the cavity 20. Upper and lower stems 36, 38 extend into the illustrated cavity 20 and drive the gate 24 up and down as desired to open and close the conduit 18. In addition, the gate 24 and seats 28 of this particular valve are said to partially float, allowing some sideways movement thereof in the cavity 20.

One example gate valve 14 with which the inserts 40 may be useful in certain oilfield related application is an API 6A full-bore, through-conduit valves having 4 1/16″, 5⅛″, 7 1/16″ or larger or smaller bores (e.g., that allow downhole tools to be passed through the wellhead and/or Christmas tree). A presently commercially available series of gate valves 14 sometimes used in hydrocarbon well fracturing operations, for example, is the Valveworks USA FM Series of gate valves, such as shown in the brochure entitled “Valveworks USA When Pressure Demands Quality® Gate Valves FM Series”, available at https://www.valveworksusa.com/wp-content/uploads/2019/04/FM-SERIES-BROCHURE.pdf, a copy of which is be provided with an Information Disclosure Statement in the file history of this patent and which is incorporated herein by reference in its entirety. See also https://www.valveworksusa.com/fm-series/.

When the illustrated valve 12 is used in oilfield fracking and related operations, for example, downhole tools, frac fluid, proppant, acid, etc. can be passed from surface (on the left), through the valve conduit 18 (to the right) into the well. Likewise, anything coming up out of the well will pass through the illustrated valve conduct 18 from right to left. During various operations, one or more grease pumps is fluidly coupled to one or more lubricant injection ports to the cavity 20, such as to continuously or intermittently (at every stage or certain stages of the process) provide grease into the cavity 20 and/or maintain the cavity 20 at a desired pressure or pressure range (e.g., around 500 psi. above frac-pressure). If a leak occurs between the conduit 18 and cavity 20, or pressure in the cavity 20 gets below frac-pressure, the system may be configured so the grease pumps inject grease into the cavity 20. Additionally, every time the valve 12 is opened during operations (e.g., four times in a few hours), a plug of grease in the cavity 20 (often a volume of about ½ the size of the cavity 20) may be pumped downhole into the earth, and is often replaced in the valve 12 by sand and other earthen debris. The result can be a potentially debilitating debris/grease combination packed (e.g., at over 10,000 psi) in the cavity 20 and around the internal components 23, which then needs to be pushed out with fresh grease.

However, the valve 12 could have different components and a different configuration and operation, none of which are limiting upon the present disclosure or appended claims, except and only to the extent as may be expressly specified otherwise herein or in any particular claims hereof and only for such specific references or claims and other claims depending therefrom. Moreover, the inserts 40 can be used in any other desired type of equipment 10 and are thus not limited to only use in valves 12. In fact, the precise type, form, nature, configuration, components, purpose and other details and characteristics of the equipment 10 are not limiting upon the present disclosure or appended claims, except and only to the extent as may be expressly specified otherwise herein or in any particular claims hereof and only for such specific references or claims and other claims depending therefrom. Likewise, the precise form, nature, configuration, size, location, purpose and other details and characteristics of the cavity, or cavities, 20 is not limiting upon the present disclosure or appended claims, except and only to the extent as may be expressly specified otherwise herein or in any particular claims hereof and only for such specific references or claims and other claims depending therefrom. For example, one or more inserts 40 may be used to occupy at least part of the cavity or cavities 20 in vehicle fuel tanks, such as when it is wanted to limit vehicle operating time or driver behind-the-wheel time (e.g., to comply with DOT and/or company regulations), for any other purposes or a combination thereof. For another example, one or more inserts 40 may be used to occupy at least part of a cavity or cavities 20 designed to be filled with air or gas, such as vehicle tires. Using one or more inserts 40 to reduce the space inside the cavity 20 can, in some instances and applications, allow the item to be used as intended with less air or gas, requiring less time and manpower to fill the item and less energy to fuel air/gas pumps, for any other purposes or a combination thereof.

Still referring to FIGS. 1-4, the exemplary insert(s) 40 may be used for any desired purpose(s). For example, the inserts 40 may be configured to allow and not impede the normal movement of internal components 23 in the equipment 10. In the illustrated embodiments, the inserts 40 are sized and positioned to allow the normal full range of up-and-down movement of the gate 24 in the cavity, as well as any permitted side-by-side movement of the gate 24 and seats 28. For another example, the inserts 40 could allow for or encourage sufficient flow of lubricant (or other fluids) in the cavity and flushing, or cleaning, of the equipment 10, without disturbing, or affecting, the normal operation of the equipment 10. For yet a further example, the insert(s) 40 may be used in the equipment 10 to occupy areas in the cavity 20 that would otherwise be filled with fluids, and, consequently, reduce, or minimize, the volume of fluid (e.g., lubricant, grease, oil, hydraulic fluid, air, natural gas, other substances, etc.) that would otherwise typically occupy or flow through part or all of the cavity or cavities 20 therein, or may be continuously or repeatedly injected, pumped or otherwise provided into and through the equipment 10, during typical or expected operations, without jeopardizing or diminishing the desired functioning of the equipment 10 and its components.

In the use of certain types of valves 12 (e.g., gate valves 14), for example, each exemplary insert 40 can at least partially fill one or more cavities 20 in the valve 12 that would otherwise become at least partially filled with or occupied by grease (or other lubricant) in the valve 12 and thus reduce the volume of lubricant provided in, cycled or passing through the equipment 10. Generally, the less open space in the cavity 20 of the valve 12 (or other equipment 10) due to the presence of one or more inserts 40, the less lubricant that will be provided into and pushed out of the valve 14 during each valve open/close cycle. In accordance with the present disclosure, the use of inserts 40 could reduce the volume of lubricant injected into the valve 12 and which may be pumped into the earth (e.g., by 50%), thus improving ESG and saving substantial time, cost, effort and resources. For an oilfield service company running five hundred such valves 12 per day, for example, the use of inserts 40 has been estimated to save at least $400,000.00/month in grease alone. In addition, the less lubricant needed on a job can translate to smaller-sized and fewer lubrication (e.g., grease) pumps needed, a smaller environmental footprint and savings in cost and effort in the purchasing, storage, inventor management, transportation, supply, use, cleanup and disposal of lubricant. In oilfield related operations, for example, fewer smaller grease pumps may be used to service more wells/valves 12. Accordingly, the use of inserts 40 could save cost, manpower and equipment, reduce the quantity of materials needed and provide other benefits associated therewith, reduce waste disposal requirements and environmental impact, provide other benefits or a combination thereof.

For another example purpose, the insert(s) 40 may likewise reduce, or minimize, the area in the cavity or cavities 20 of the equipment 10 within which debris (e.g., sand, metal shavings, proppant, etc.) can accumulate and be packed into during operations (e.g., at over 10,000 psi for various valves used in hydrocarbon well fracturing and other operations), thus reducing the accumulation of debris in the equipment 10. This can result fewer problems caused by debris, the potential for less frequent inspections, less maintenance, repair and replacement and greater longevity of the equipment 10. The use of the insert(s) 40 in the equipment 10 can also make cleaning, maintenance and repair of the equipment 10 easier and quicker and improve the performance and efficiency of the equipment 10 and related operations.

Still referring to FIGS. 1-4, in various embodiments, the use of one or more exemplary inserts 40 in various types of equipment could reduce substantial volumes of lubricant, other fluids, substances, debris, etc. that would otherwise be injected, supplied and/or packed into or driven through and out, the equipment 10 during typical or expected operations. For example, with various types of equipment 10 involving the continuous or repeated pumping of fluid (e.g., oil, hydraulic fluid, etc.) through the cavity (e.g., to pressurize the equipment 10), the savings becomes exponential. In exemplary gate valves 14 used in typical hydrocarbon well fracturing, for example, the presence of the exemplary insert(s) 40 in the cavity 20 of the valve 14 has shown to reduce the volumes of lubricant, other fluids, substances, debris etc. by at least 50% (could be more or less depending upon the particular situation and circumstances) that would otherwise normally or typically be injected, supplied and/or packed into, and may be driven through and out, the valve 14, such as during multiple open/close cycles of the valve 14 in short time intervals. For another example, the size of the cavity or cavities 20 of and/or operating pressure ranges of various equipment 10 may be substantial and normally allow substantial volumes of fluid (e.g., lubricant) to be supplied into and/or through the equipment 10 during typical or expected operations. The use of one or more exemplary inserts 40 in such large cavities 20 could thus reduce substantial volumes of lubricant, other fluids, substances, debris, etc. An exemplary API 6A gate valve 14 presently used in various oilfield related operations, for example, may possess a barrel-shaped internal cavity 20 having an inner diameter of approximately 11¾″ and length of approximately 30″, operate under up to 15,000 psi of pressure (e.g., 500 psi (or more or less) over frac-pressure (e.g., at least approximately 12,000 psi) in well fracking operations) and run through four or so gate open/close cycles in a few hours. Accordingly, any percentage reduction in the volume of lubricant, debris, substances etc. passing through large cavities 20 could amount to substantial volumes saved or reduced.

However, the present disclosure and appended claims are not limited by or to any of the above examples, features, dimensions, variables and operating conditions, or those that may be mentioned elsewhere in this patent, except and only to the extent as may be expressly specified otherwise herein or in any particular claims hereof and only for such specific references or claims and other claims depending therefrom. And as indicated above, the present disclosure is not limited to or by the type, make, model, manufacturer or size of valve 12 or other equipment 10, or the size, shape, location, quantity and configuration of cavities 20 therein.

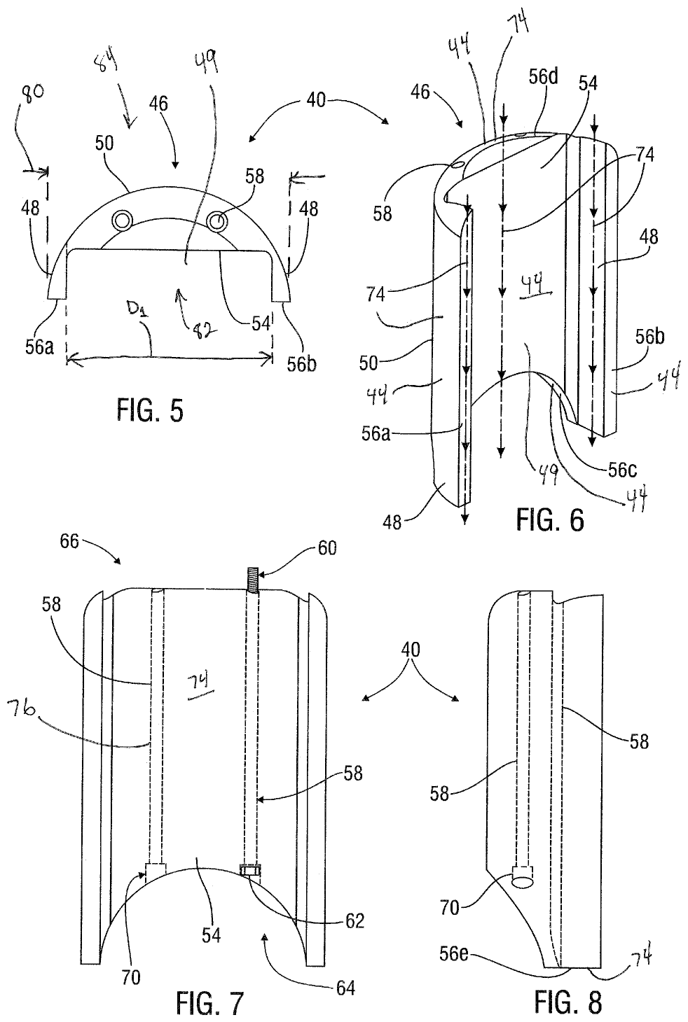

Referring now to FIGS. 5-8, the insert 40 may have any suitable form, components and construction. In some embodiments, the exemplary insert(s) 40 may be permanent or temporary, provided as part of the original manufacturing or assembly of the equipment 10 or internal components 23 and/or provided to retrofit existing equipment 10. For example, the inserts 40 may be configured to be easily added to retrofit pre-existing equipment 10 (e.g., valves 12), as well as included with new equipment 10 and easily removable to allow for servicing, maintenance, replacement, etc. of the insert 40, equipment 10 and/or internal components 23 therein, for any other purposes or a combination thereof.

If desired, the inserts 40 may be designed to be identical and/or interchangeable, such as to assist in ease of manufacture, inventory management, supply, handling, operator training, etc., provide maximum flexibility in their deployment, maintenance and replacement, for any other purposes or a combination thereof. For example, when multiple inserts 40 are used in an item of equipment 10, any of the (identical and interchangeable) inserts 40 may be used in any of the different portions of the cavity 20. This is the case for the embodiments of inserts 40 shown in FIGS. 5-8 and FIGS. 9-11, respectively. In other embodiments, different inserts 40 may have different features, such as for use in differently shaped or configured portions of a cavity 20, or for use in different cavities 20 in the equipment 10, to accomplish different objectives at different locations in the cavity 20 or equipment 10, for any other purposes or a combination thereof.

The material construction of the insert 40 may, in some instances, be selected based upon the type of equipment 10 within which the insert 40 is used, particular use and/or operating environment of the equipment 10 (e.g., pressure, temperature), customer requirements, any other criteria or a combination thereof. For example, the insert 40 may be constructed at least partially of plastic, metal, Delrin, composite material, acid-resistant, temperature-resistant, corrosion-resistant heavy-duty, durable or flexible material, foam, Styrofoam, rubber, lightweight material, any other suitable materials and any desired coatings or a combination thereof.

In the illustrated embodiments, the insert 40 is unitary (formed of one integral piece), helping allow it to withstand the full working pressure and temperature ranges of the valve 12 or other equipment 10 within which it is used, provide ease of manufacture and assembly and other benefits from not having multiple component parts (e.g., purchasing, inventory, storage, transportation, manpower), provide more consistent, reliable or predictable operation of the insert 40 and results, require less maintenance and last longer than multi-component inserts 40, provide any other benefits or a combination thereof. Other embodiments may include a multi-component insert 40 (e.g., connected together by weld, bolt(s), pin(s), etc.). In various embodiments, the size of the insert 40 may be adjustable (e.g., having removable, stackable, periscoping, accordion-like or otherwise expandable and/or contractable components or features), such as to accommodate different sized cavities 20, be varied in size or configuration based upon the objectives of a project or application, for any other purposes or a combination thereof.

Referring again to FIGS. 1-4, the insert 40 may likewise have any suitable shape, size and configuration. For example, the insert 40 may be sized to be smaller (e.g., by ¼″ or more or less around all or part of its periphery) than that portion of the cavity 20 it occupies, so it will be spaced-apart from all or part of the cavity wall 22 and/or one or more internal components 23 therein, to help allow fluid to pass thereby in the cavity 20, allow internal components 23 to move as normally expected in the equipment 10, for any other purposes or a combination thereof. For another example, the insert 40 may have one or more outer surfaces 44 (e.g., FIG. 6) and/or other features shaped and/or configured to correspond with the shape of at least part of the cavity 20, one or more internal components 23 of the equipment 10 or one or more other inserts 40 to help allow fluid to pass thereby, allow internal components 23 to move as desired in the equipment 10, for any other purposes or a combination thereof. In the embodiment of FIGS. 5-8, for example, the insert 40 has a main body 46 with a rear surface 50 that is at least partially curved and configured to correspond with the curved, or barrel, shape of the illustrated cavity wall 22 (e.g., FIGS. 1-4), a front surface 54 that is at least partially flat to correspond with the adjacent shape of the gate 24 and a pair of opposing legs 48 extending forward from the main body 46 to at least partially surround the gate 24 and allow its normal movement in a space 49 formed between the legs 48. For example, the distance D₁ between the legs 48 may be greater than the width W₁ of the gate 24 (e.g., FIG. 3) to allow the gate 24 to move undisturbed by the insert 40. While the illustrated insert 40 has an overall generally C-shape, it could have any other desired outer shape.

The illustrated insert 40 also has an at least partially curved upper edge 56d configured to correspond with the shape of a counterbore 34 provided in the removable portion 32 of the equipment 10 that it extends into, and an at least partially curved central lower edge 56c configured to partially surround, be spaced away from, avoid contact with and allow movement of an adjacent seat 28 in the equipment 10 (e.g., FIG. 2). However, the insert 40 may have any other suitable shape, size and configuration. For example, the insert 40 may fit snugly within the cavity 20, at least partially abut and/or form a seal with the cavity wall 22 and/or one or more internal components 23 in the equipment 10, have one or more outer surfaces 44 not shaped to correspond with or accommodate the shape of the cavity wall 22, internal components 23 or other inserts 40, have any other desired features or a combination thereof.

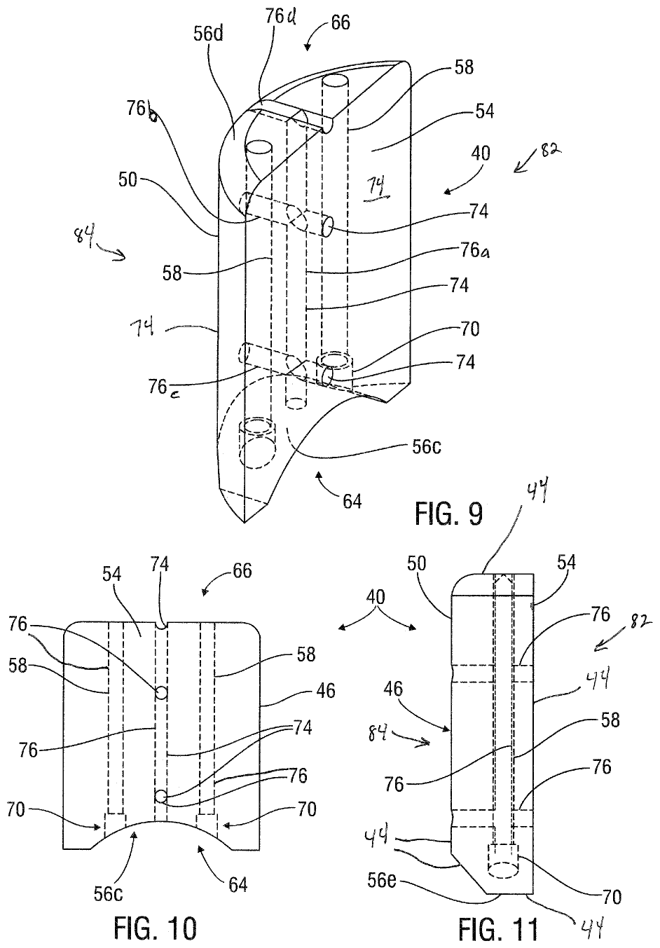

Referring now to FIGS. 9-11, in some embodiments, the insert 40 may be formed without any protrusions extending outwardly therefrom to help prevent any part of the insert 40 from breaking off during use of the equipment 10, maintain the insert's integrity and withstand the forces and abrasion of high-pressure fluid (and materials) in the cavity 20, for any other purposes or a combination thereof. This may be important, for example, in applications where the insert 40 will be subject to high fluid pressures in the cavity 20. In various hydraulic fracturing related operations, for example, inserts 40 may be used in gate valves 14 where lubricant is injected into and maintained in the cavity 20 at high pressures, such as over 10,000 psi. In the illustrated embodiment, the insert 40 does not include the legs 48 and has no projections or protrusions extending outwardly therefrom.

In some embodiments, the insert(s) 40 may eliminate the need for, replace or serve the purpose as one or more other components in the equipment 10. For example, in certain situations, when one or more exemplary inserts 40 are used with various versions of valves 12 (e.g., gate valves 14), the inserts 40 may be capable of serving the same purpose as gate guides in the valve 14 and thus eliminate the need therefor. HOWEVER, IT IS STRONGLY RECOMMENDED THAT ANY USER OF THE INSERT 40 NOT MODIFY THE VALVE OR OTHER EQUIPMENT IN ANY WAY, OR TAKE ANY ACTION, THAT CONTRADICTS OR GOES OUTSIDE OR AGAINST OEM SPECIFICATIONS, RECOMMENDED OPERATING, REPAIR OR MAINTENANCE PROCEDURES, OR OTHER RECOMMENDATIONS, INSTRUCTIONS, REPRESENTATIONS, ASSEMBLY OR USE GUIDELINES OR ADVICE OF ANY RELEVANT PARTY OR WITHOUT THE PERMISSION OF THE SUPPLIER AND END-USER OF THE EQUIPMENT.

Referring back FIGS. 1-4, the exemplary insert 40 may be designed to occupy any desired space(s) with the cavity or cavities 20 of the valve 12 or other equipment 10. In this embodiment, four inserts 40 are used, each insert 40 being configured to fill a quarter-section of the exemplary cavity 20, minus sufficient space in the cavity 20 around the insert 40 to allow the desired flow of fluid thereby and/or unimpeded movement of internal components 23 in the cavity 20, for any other purposes or a combination thereof. The illustrated configuration has first and second opposing upper insert's 40a, 40b facing each other in an upper portion 20a of the cavity 20 and first and second opposing lower insert's 40c, 40d facing each other in a lower portion 20b of the cavity 20. Other embodiments may include more or fewer inserts 40, such as only one insert 40 in the cavity 20, a single insert 40 in the upper portion 20a and a single insert in the lower portion 20b, a single insert in a left portion of the cavity 20 and a single insert in a right portion of the cavity 20, or any number of inserts 40 (e.g., 3, 5, 6 or more) in any other configuration at any desired locations in the cavity or cavities 20. Further, one or more inserts 40 can occupy less space in the cavity 20 (e.g., 50-90% of a cavity's quarter-section or more or less) or completely fill the cavity 20 or a portion thereof. Moreover, different inserts 40 can occupy different amounts of space in the cavity 20.

Referring still to FIGS. 1-4, in yet another independent aspect, the exemplary inserts 40 are shown not touching or abutting one another, such as to allow the flow of fluid therebetween, for any other purpose or a combination thereof. In other embodiments, one or more inserts 40 could be configured to contact one or more other inserts 40. For example, the exemplary upper inserts 40a, 40b could abut one another at either or both of their respective (e.g., flat) front edges 56a, 56b, the lower inserts 40c, 40d could abut one another at either or both of their respective front edges 56a, 56b, the upper insert 40a could abut the lower insert 40c at their respective lower outer edges 56e, the upper insert 40b could abut the lower insert 40d at their respective lower outer edges 56e or a combination thereof. In yet other embodiments, any other abutting arrangement of one or more inserts 40 with one or more other inserts 40 may be employed.

In another independent aspect, the exemplary insert 40 may be configured to be connectable to the equipment 10, any internal component(s) 23 therein, one or more other inserts 40 or a combination thereof. This may be helpful, for example, to secure the position of the inserts 40 for shipping, storage, operation and disassembly, help prevent undesirable movement (e.g., vibration, rotational, side-to-side, up-and-down) of the insert 40 during use of the equipment 10, allow easy installation and removal of the insert 40, assist in allowing the flow of fluid at least partially around the insert 40, for any other purposes or a combination thereof.

The insert(s) 40 may be connectable to the equipment 10, any internal component(s) 23 thereof, one or more other inserts 40 or a combination thereof in any suitable configuration and manner. In some embodiments, one or more inserts 40 may be coupled to the main body 16, or other portion, of the equipment 10 (e.g., valve 12). For another example connection configuration, the inserts 40 may be (e.g., selectively, releasably) interconnectable with each other, such as to easily secure their positions in the cavity 20, help prevent undesirable movement thereof in the cavity 20 and/or for any other purposes. In some instances, the inserts 40 can be connected together, but with at least one insert 40 also coupled to an adjacent removable portion 32 or other part of, or component 23 in, the equipment 10 to help prevent unwanted movement thereof in the cavity 20 and/or for any other purposes.

In some embodiments, the insert(s) 40 may be permanently affixed (e.g., by weld) to, or integrally formed as part of, the equipment 10, any internal component(s) 23, one or more other inserts 40 or a combination thereof. For example, when the equipment 10 is a valve 12, each insert 40 may be integrally formed as part of, or permanently affixed to, one of the bonnets 32 (or other valve component). In yet other embodiments, the insert 40 may be loosely connectable (allowing flexing or some movement of the insert 40) or not connectable to the equipment 10, any components 23 therein or other inserts 40. For example, there may be instances where some movement of one or more inserts 40 is desired or allowable. For another example, it may be beneficial or preferred for the inserts 40 to be independent of one another, such as to allow the independent movement thereof in, or to and from, the cavity 20. For yet another example, the insert(s) 40 may be configured and arranged in the equipment 10 in a manner that prevents undesirable movement thereof without the need for connecting them to anything, or by connecting the inserts 40 to one another. For still a further example, one or more inserts 40 may effectively float in the cavity 20 (e.g., in lubricant surrounding the insert 40) to produce the desired effects.

In some cases, one or more inserts 40 may be engageable with one or more portions/components of the equipment 10 that are movable relative to the main body 16 (or other portions/components) of the equipment 10. In other embodiments, one or more inserts 40 may be engageable with one or more portions/components of the equipment 10 that are not movable relative to the main body 16, or other portions/components, of the equipment 10. For another example, the insert(s) 40 may be connected to one or more portions/components of the equipment 10 that are removable from the equipment 10. Connecting the exemplary insert(s) 40 with only one or more removable portions/components of the equipment can easily position the inserts 40 as desired in the cavity 20, allow the inserts 40 to be easily installed and removed from the equipment 10 by merely disconnecting the removable portion(s)/component(s) from the equipment 10 and easily provide immediate and/or full access to the cavity 20, provide other benefits or a combination thereof. With such arrangement, time and effort can be saved and potential safety concerns reduced in the assembly, disassembly and repair of the equipment 10, internal components 23 and inserts 40, including emergency field repair (e.g., valve 12 not sealing, gate 24, seat(s) 28, seals or other internal components 23 damaged).

In the present embodiments, each insert 40 is rigidly, releasably connectable to the adjacent respective upper or lower removable portions 32a, 32b (e.g., end pieces or bonnets) of the equipment 10 (e.g., valve 12). For example, the illustrated upper inserts 40a, 40b can be coupled to the upper removable portion 32a and the exemplary lower inserts 40c, 40d may be coupled to the lower removable portion 32b. The upper inserts 40a, 40b will thus be easily removed from the cavity 40 by merely disconnecting the upper removable portion 32a from the main body 16 of the equipment 10 (e.g., by removing bolts 33) and likewise for the lower inserts 40c, 40d and the lower removable portion 32b. However, any other configuration that allows easy insertion and removal of the insert(s) 40 from the equipment 10 may be used.

Referring back to FIGS. 5-11, the exemplary insert 40 includes at least one connector passage, or hole, 58 extending at least partially therethrough and through which a connector 60 (e.g., socket head cap screw, bolt, pin, etc.) can be inserted and secured to the desired part of the equipment 10, internal component 23 or other insert 40. For example, one or more connector holes 58 may extend between the upper and lower ends 66, 64 and/or between the front and rear ends 82, 84 of the exemplary insert 40 or in any other arrangement. A connector 60 may be insertable in each connector hole 58 from the lower end 64 of the insert 40 (e.g., FIG. 7) and thereafter releasably, rigidly secured (e.g., via threadable engagement) to a corresponding receiving hole 68 (e.g., FIG. 2) formed in the equipment 10, such as the adjacent removable portion 32 at the upper end 66 of the insert 40. HOWEVER, IT IS STRONGLY RECOMMENDED THAT ANY USER OF THE INSERT 40 NOT MODIFY THE VALVE OR OTHER EQUIPMENT IN ANY WAY, OR TAKE ANY ACTION, THAT CONTRADICTS OR GOES OUTSIDE OR AGAINST OEM SPECIFICATIONS, RECOMMENDED OPERATING, REPAIR OR MAINTENANCE PROCEDURES, OR OTHER RECOMMENDATIONS, INSTRUCTIONS, REPRESENTATIONS, ASSEMBLY OR USE GUIDELINES OR ADVICE OF ANY RELEVANT PARTY OR WITHOUT THE PERMISSION OF THE SUPPLIER AND END-USER OF THE EQUIPMENT.

In some instances, it may be beneficial to have more than one connection point for each exemplary insert 40, such as to help firmly secure the insert 40 to the equipment 10, prevent rotation of the insert 40 in the cavity 20, for any other purposes or a combination thereof. The illustrated embodiments include the provision for a pair of connectors 60 extending through connection holes 58 in each insert 40 to help firmly releasably, secure it to the equipment 10 and prevent its rotation, however only one, or three or more, connectors or connection points may be used. If desired, the insert 40 may include a counterbore, or recessed portion, 70 at the insertion end of the connector hole 58 (or other location) in which a head 62 (or other part) of the connector 60 may be sunken or hidden and not protruding outward of any outer surface 44 of the insert 40 during use of the equipment 10, such as to prevent its rubbing, grinding or contact with other inserts 40, internal components 23 or the equipment 10, help prevent the connector 60 from being broken or damaged, for any other purposes or a combination thereof. Thus, in the present embodiments, the inserts 40 can be easily and quickly added to, positioned in and removed from the equipment 10 by merely coupling two upper inserts 40a, 40b to the upper removable portion 32a (or other part or component) of the equipment 10 with two connectors 60 and coupling two lower inserts 40c, 40d to the lower removable portion 32b (or other part or component) of the item 10 with two connectors 60. However, fewer or more than two connector holes 58 (e.g., 3, 4, 5, etc.) extending in, or through, any (other) portions of the insert 40, or any other connection techniques, arrangements and components (e.g., corresponding mating portions) may be used for connecting the insert 40 to the equipment 10, one or more internal components 23 or one or more other inserts 40.

In various embodiments, the insert 40 may instead or also be interference fit or otherwise mateably engaged (e.g., threaded connection, snapping engagement, pin/socket connection, etc.) with the equipment 10, one or more internal components 23, one or more other inserts 40 or a combination thereof, to position the insert 40 in the equipment as desired, prevent its movement in the cavity 20, for any other purposes or a combination thereof. Any other connection configuration for one or more inserts 40 may be used to achieve the desired result (e.g., secure the position of the inserts 40 in the equipment 10, prevent their rotation, etc.).

Referring now to FIGS. 2 & 6, in another independent aspect, the exemplary insert 40 may include, or provide, one or more fluid flow paths 74. The fluid flow paths 74 may be useful to allow lubricant (e.g., grease) or other fluids (substances, materials, etc.) to travel as needed or desired within the equipment 10 (e.g., as dictated by manufacture's specifications, particular field use requirements, etc.), help sufficiently lubricate the equipment 10 and/or one or more internal components 23, allow desired pressurization in the equipment 10, help flush debris through the cavity 20, help clean the insert 40 and equipment 10 (e.g., valve flushing/debris removal) for any other purposes or a combination thereof.

The fluid flow paths 74, when included, may have any suitable form, configuration, construction, location and operation. For example, the insert 40 may be shaped, sized and/or positioned in the equipment 10 (e.g., valve 12) to form or allow one or more fluid flow paths 74 around at least part of the insert 40. In the illustrated embodiments, the insert 40 is configured and positioned not to fully occupy the entire space in its portion of the cavity 20, so that lubricant (e.g., injected into the valve 12 under pressure) and/or any other desired fluids, materials, etc. may flow in one or multiple flow paths 74 around and by the outer surfaces 44 of the insert 40. In some instances, fluid may flow in the fluid flow paths 74 around the entire periphery of the insert 40 (excluding the location of any connectors 50 or other connection mechanisms). For example, in use of the exemplary inserts 40 in the valves 12 for fracking-related operations, the inserts 40 will typically be substantially or entirely covered with grease during operations.

In the present embodiments, fluid flow paths 74 are created by generally spacing each insert 40 away from the wall(s) 22 of the cavity 20, internal components 23 and other inserts 40 in the cavity 20. For example, the outer diameter, or width, 80 of each insert 40 may be smaller than the width, or diameter, 30 (FIG. 3) of the cavity 20, forming fluid flow paths 74 along the outer surface 50 of the insert 40. For another example, each illustrated insert 40 may be positioned and sized to provide spaces, and thus fluid flow paths 74, with internal components 23 and between adjacent inserts 40, allowing for lubricant travel and flushing around the inserts 40 and internal components 23 (e.g., gate 24 and seats 28) in the cavity 20. For yet a further example, one or more of the outer edges 56a-e of the insert 40 may be formed with one or more curved corners (see e.g., upper edge 56d, FIGS. 6 & 9) or other shapes or configurations that may encourage or allow the flow of fluid thereby. For still another example, the absence of legs 48, or other protrusions, extending from the insert 40 (e.g., FIGS. 9-11) may provide additional room for fluid flow thereby.

Referring to FIGS. 9-11, the fluid flow paths 74 may include one or more fluid passageways 76 formed in the insert 40 to allow lubricant and/or any other desired fluids, materials, etc. to travel therethrough from one part to another part of the cavity 20 or equipment 10. The fluid passageways 76 may have any suitable configuration, location, size and orientation. In this embodiment, a first fluid passageway 76a extends longitudinally through the insert 40 (e.g., spaced apart from the connector holes 58) between the upper and lower ends 66, 64 thereof and is intersected by second and third respective fluid passageways 76b, 76c extending at different respective heights through the thickness of the insert 40 between its front and rear ends 82, 84. A fourth fluid passageway 76d in the form of a channel is shown formed in the upper edge 56d of the illustrated insert 40 to encourage the flow of lubricant or other fluids or materials from the front end 82 to the rear end 84 of the insert 40 and into the first (longitudinal) fluid passageway 76a. In the illustrated insert 40, a fluid pass-through system is thus provided, allowing fluid flow between one or more portions of the cavity 20 forward and rearward of, and above and below, the insert 40. In some situations when one or more connector passages 58 are provided in the insert 40, but not used to carry a connector 60 therein, the connector passages 58 can serve as fluid passageways 76. However, any other form, configuration, location and quantity of fluid flow paths 74 and fluid passageways 76 may be provided. Moreover, some embodiments may not have any fluid flow paths 74 and/or fluid passageways 76.

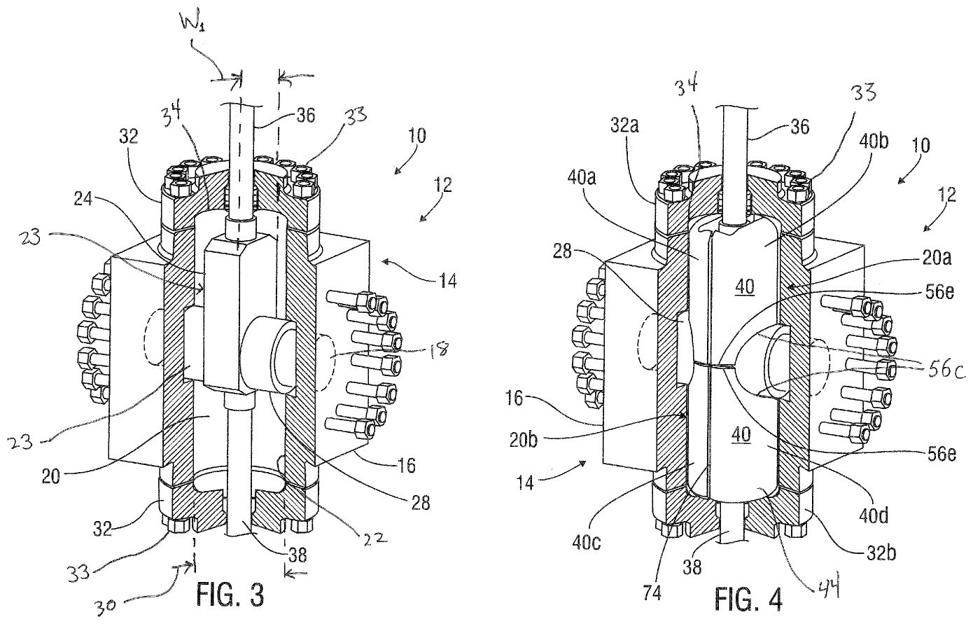

Referring now to FIGS. 2 and 4, the insert 40 may be installed or provided in the cavity or cavities 20 of the subject equipment 10 in any suitable manner. As mentioned above, for example, one or more inserts 40 may be integral with, formed as part of, affixed to or installed in the equipment 10 or any components thereof when the equipment 10 is manufactured and/or thereafter. In the present embodiment, the inserts 40 may be easily, releasably installed in the equipment 10, for example, by removing one removable portion 32 from the equipment 10, coupling two inserts 40 to the removed removable portion 32 and inserting the other two inserts 40 into the cavity 20 to couple them to the other removable portion 32 still in the valve 12. In other words, removal of the upper removable portion 32a from the equipment 12 may, in some embodiments, allow sufficient access to the cavity 20 to insert the exemplary lower inserts 40c, 40d into the cavity 20 and couple them to the lower removable portion 32b (still in the equipment 10). Likewise, removal of the lower removable portion 32b from the equipment 10 may allow sufficient access to the cavity 20 to install the exemplary upper inserts 40a, 40b in the cavity 20 and couple them to the upper removable portion 32a (still in the equipment 10).

If desired, one or more removable portion 32 (or other portions or internal components 23) of the equipment 10 may include a mechanism, such as a counterbore, or recess, 34, that the upper end 66 (or other part) of the corresponding insert 40 may at least partially extend into, such as to help position the insert 40 in, or secure the insert 40, to the equipment 10 and/or for any other purposes. However, any other techniques and components may be used for installing or providing the insert(s) 40 in the equipment 10. Moreover, the material construction, size, configuration, dimensions, disposition and other features and characteristics of the insert 40 may vary depending upon the equipment 10, particular applications, circumstances and objectives, other variables or a combination thereof.

Referring to FIGS. 2 & 4, in another independent aspect, an exemplary method of lubricating and/or improving usefulness of an equipment item 10 (e.g., valve 12) will now be described. The exemplary equipment item 10 has an internal cavity 20 and at least one lubricant insertion or injection port (not shown) fluidly coupled to the cavity 20. One or more exemplary inserts 40 is provided in the cavity 20 and during operation of the equipment 10, lubricant may be inserted or injected into the cavity 20 as needed, or continuously, through at least one lubricant injection port. At least one exemplary insert 40 in the cavity 20, by occupying space in the cavity 20, can reduce the volume of lubricant provided in the equipment 10. In various embodiments and applications, the insert(s) 40 can assist in directing the flow of lubricant through at least part of the cavity 20, partially inhibit the flow of lubricant in the cavity 20, change the volume and rate of flow and/or fluid pressure of lubricant in the cavity 20, provide other sought-after results or a combination thereof. If desired, at least one insert 40 can allow lubricant to flow around the entire periphery of the insert 40 or a portion thereof and/or allow lubricant to flow through the insert 40, from at least one portion of the cavity 20 to at least one other portion 20 of the cavity. If debris may typically collect in the cavity 20, at least one insert 40, due to its occupancy of space in the cavity 40, may reduce the amount of debris collected in the cavity 20 which can diminish the ability to lubricate the equipment 10, thus improving lubrication, effectiveness, efficiency and operability of the equipment 10.

Referring still to FIGS. 2 & 4, in another independent aspect, an exemplary method of cleaning an equipment item 10 (e.g., valve 12) having at least one removable portion (e.g., removable portion 32, part of the main body 16, etc.) and one or more cavities 20 within which lubricant is provided and debris enters during operation of the equipment 10 will now be described. At least one insert 40 is secured to the removable portion of the equipment 10. The removable portion is then secured to the equipment 10, which positions the insert(s) 40 in a desired position in the cavity 20. Each exemplary insert 40 provides one or more fluid flow paths 74 around the insert 40 and one or more fluid passageways 76 through the insert 40, which allow lubricant to pass around and through the insert 40, respectively, during operation of the equipment 10. The removable portion of the equipment 10 (with the insert(s) 40 coupled thereto) is removed from the equipment 10. The fluid flow paths 74 are fluid passageways 76 are flushed to remove lubricant and debris therefrom and the removable portion of the equipment 10, with the insert(s) 40 coupled thereto is returned to the equipment 10. If desired, the cavity 20 may be flushed to remove lubricant and debris therefrom. In some embodiments, two inserts 40 may be coupled to the removable portion of the equipment 10. In some embodiments, the removable portion may be an end piece 32, two end pieces 32 may be included in the equipment 10 and at least one (e.g., two) inserts 40 may be secured to each end piece 32.

Preferred embodiments of the present disclosure thus offer advantages over the prior art and are well adapted to carry out one or more of the objects of this disclosure. However, the present disclosure does not require each of the components and acts described above and is in no way limited to the above-described embodiments and methods of operation. Any one or more of the above components, features, aspects, capabilities and processes may be employed in any suitable configuration without inclusion of other such components, capabilities, aspects, features and processes. Accordingly, embodiments of the present disclosure may have any one or more of the features described or shown in this patent. Moreover, the present invention includes additional features, capabilities, functions, methods, uses and applications that have not been specifically addressed herein but are, or will become, apparent from the description herein, the appended drawings and claims.

The methods that may be described above, claimed herein or are apparent from this patent and any other methods which may fall within the scope thereof can be performed in any desired or suitable order and are not necessarily limited to any sequence described herein or as may be listed in any appended claims. Further, the methods of various embodiments of the present disclosure may include additional acts beyond those mentioned herein and do not necessarily require use of the particular embodiments shown and described herein, but are equally applicable with any other suitable structure, form and configuration of components.

While exemplary embodiments have been shown and described, many variations, modifications and/or changes of the system, apparatus, articles of manufacture and methods of the present disclosure, such as in the features, components, details of construction and operation and arrangements thereof and the manufacture, assembly and use thereof, are possible, contemplated by the present patentee, within the scope of any appended claims, and may be made and used by one of ordinary skill in the art without departing from the spirit, teachings and scope of this disclosure and any appended claims. Thus, all matter herein set forth or shown in the accompanying drawings should be interpreted as illustrative and the scope of this disclosure and any appended claims should not be limited to the embodiments described or shown herein.

1. System for reducing the volume of fluid provided in the internal cavity of an item of equipment which normally involves the inclusion of fluid in the cavity and may have one or more internal components at least partially disposed within the cavity, at least one of which may be moveable in the cavity, the cavity being at least partially surrounded by at least one cavity wall, the system comprising:
at least two removable inserts, each insert configured to occupy a different respective portion of the cavity without impeding movement in the cavity of any movable internal components of the equipment during use thereof, each insert being arranged and adapted to be spaced away from the at least one cavity wall, any internal components and the other at least one insert when the inserts are disposed in the cavity, each insert also being configured to form a plurality of fluid flow paths around the insert, whereby fluid can pass around at least part of each insert in the cavity when the insert is disposed in the cavity, the inserts being interchangeable so that any of the inserts can be used in any of the different portions of the cavity.

2. The system of claim 1 wherein at least one insert has at least one outer surface, further including at least one fluid flow path extending at least partially across at least one outer surface of the insert.

3. The system of claim 1 wherein at least one insert has front and rear ends, further including at least one fluid passageway extending through the insert from the front end to the rear end thereof and fluidly coupling one or more portions of the cavity forward and one or more portions of the cavity rearward of the insert when the insert is disposed in the cavity.

4. The system of claim 1 wherein at least one insert has upper and lower ends, further including at least one fluid passageway extending through the insert from the upper end to the lower end thereof and fluidly coupling one or more portions of the cavity above and one or more portions of the cavity below the insert when the insert is disposed in the cavity.

5. The system of claim 1 wherein at least one insert consists of a single unitary body having no protrusions extending outwardly therefrom and is configured to maintain its integrity and withstand the forces and abrasion of high-pressure fluid in the cavity.

6. The system of claim 1 wherein the inserts are configured to be used in the equipment item without modifying the equipment item.

7. The system of claim 1 wherein the equipment has at least a first removable portion adjacent to, or at least partially forming, the cavity and when the inserts are disposed in the cavity, at least a first insert is configured to be secured in a desired position in the cavity by releasably engaging the first insert with only with the first removable portion of the equipment, whereby the first insert is removable from the equipment item by merely removing the first removable portion.

8. The system of claim 1 further including at least first and second spaced-apart releasable connectors configured to extend between and couple at least one insert to the equipment item when the inserts are disposed in the cavity, whereby the first and second connectors associated with at least one insert secure the insert in a desired location in the cavity and prevent rotation of the insert relative to the equipment item.

9. The system of claim 8 wherein at least one insert has upper and lower ends and first and second spaced-apart connector passages extending between the upper and lower ends thereof, the at least one insert being configured so that the associated first and second connectors are insertable into the respective connector passages from the lower end to the upper end of the insert and thereafter engageable with the equipment item.

10. The system of claim 8 wherein each connector passage is configured to serve as a fluid passageway through the corresponding insert when a connector is not disposed therein, whereby each connector passage serving as a fluid passageway fluidly couples at least one portion of the cavity above the insert with at least one portion of the cavity below the insert.

11. The system of claim 1 wherein at least one insert is rigidly, releasably connectable to at least one among the equipment item, at least one internal component and at least one other insert.

12. The system of claim 1 wherein at least one insert is not coupled to the equipment item and floats in the cavity.

13. Method of reducing the volume of fluid provided in the internal cavity of an item of equipment which normally involves the inclusion of fluid in the cavity and may have one or more internal components at least partially disposed within the cavity, at least one of which may be moveable in the cavity, the cavity being surrounded by at least one cavity wall, the method comprising:
arranging at least two removable inserts in the cavity to occupy different respective portions of the cavity and be spaced away from the at least one cavity wall and any internal components, the inserts being interchangeable so that any of the inserts can be used in any of the different portions of the cavity;
the inserts allowing movement in the cavity of any movable internal components of the equipment during use thereof without impeding such movement;
each insert forming a plurality of fluid flow paths around the insert; and
each insert allowing fluid to pass around at least part of the insert in the cavity.

14. The method of claim 13 wherein the cavity has respective upper and lower portions, further including
positioning a first pair of inserts to face each other in the upper portion of the cavity, and
positioning a second pair of inserts to face each other in the lower portion of the cavity.

15. The method of claim 13 further including
releasably coupling at least one insert to at least one among the group consisting of the equipment item, at least one internal component and at least one other insert with one or more connectors engaged therebetween, and
each insert allowing the flow of fluid around the entire periphery of the insert when the insert is disposed in the cavity except where at least one connector engages the insert if the insert is coupled to something else in the cavity.

16. The method of claim 13 wherein each insert has upper and lower ends, further including
at least one fluid passageway extending through each insert from the upper end to the lower end thereof, and
at least one fluid passageway fluidly coupling at least one portion of the cavity above and at least one portion of the cavity below the insert when the insert is disposed in the cavity.

17. System for reducing the volume of high-pressure lubricant injected into a through-conduit valve during use of the valve in oilfield related operations, the valve having an internal cavity at least partially surrounded by at least one cavity wall and at least one internal component disposed at least partially in the cavity, at least one which is movable in the cavity during use of the valve, the system comprising:
at least two removable inserts, each insert being unitary, having no protrusions extending outwardly therefrom and configured to occupy a different respective portion of the cavity without impeding movement of the at least one movable internal component during use of the valve, each insert, when disposed in the cavity, being configured to be spaced away from and allow lubricant to pass between itself and the at least one cavity wall, at least one internal component and at least one other insert.

18. The system of claim 17 wherein four inserts are used and configured to be added to the valve to retrofit the valve.

19. The system of claim 18 wherein the cavity is at least partially cylindrical and has an upper base at one end at a lower base at the other end and the valve has a removable upper bonnet adjacent to, or at least partially forming, the upper base of the cavity and a removable lower bonnet adjacent to, or at least partially forming, the lower base of the cavity, further wherein at least a first insert is releasably engageable with the upper bonnet and at least a second insert is releasably engageable with the lower bonnet.

20. The system of claim 18 wherein the first insert is secured in the valve only by engagement with the upper bonnet and the second insert is secured in the valve only by engagement with the lower bonnet and the first and second inserts are removable from the valve independent of one another merely by disconnecting the upper and lower bonnets from the valve, respectively.
